(19) United States
(12) Patent Application Publication
(10) Pub. No.: US 2023/0192524 A1
(43) Pub. Date: Jun. 22, 2023

(54) SCWO SYSTEM FOR TREATMENT OF HIGH-STRENGTH WASTES

(71) Applicant: 374Water Inc., Durham, NC (US)

(72) Inventors: Marc DESHUSSES, Chapel Hill, NC (US); Yaacov NAGAR, Durham, NC (US); David BALLENGHIEN, Romans-sur-Isère (FR); Hamutal HARIF, Durham, NC (US)

(21) Appl. No.: 18/068,287

(22) Filed: Dec. 19, 2022

Related U.S. Application Data
(60) Provisional application No. 63/265,759, filed on Dec. 20, 2021.

(51) Int. Cl. C02F 11/08

(52) U.S. Cl. CPC C02F 11/086; C02F 2301/046; C02F 2301/08; C02F 2209/40

(57) ABSTRACT

A supercritical water oxidation (SCWO) system with a well-mixed SCWO reactor, a feedstock supplied to the well-mixed SCWO reactor by a feedstock supply line, a recirculation loop flow regulator in fluid communication with the well-mixed SCWO reactor; and a recirculation loop which includes the well-mixed SCWO reactor and the recirculation loop flow regulator, such that the recirculation loop flow regulator receives an oxidant from an oxidant supply line and a first portion of a reactor effluent from the well-mixed SCWO reactor and supplies the oxidant and the first portion of the reactor effluent to the well-mixed SCWO reactor. The SCWO system also includes a heat transfer unit operationally associated with the well-mixed SCWO reactor which performs at least one of: heating the well-mixed SCWO reactor and cooling the well-mixed SCWO reactor.

### RELATED APPLICATIONS

The present application is a Non-Provisional of, and claims 35 U.S.C. 119 priority from, U.S. Patent Application Ser. No. 63/265,759 filed Dec. 20, 2021, the entire contents of which are incorporated by reference herein.

### BACKGROUND

Waste processing remains an important priority in today's society, and especially as it relates to waste which includes organic material. This waste includes sludge, which is a slurry, liquid waste, and waste with a large organic material component. One way of dealing with this waste is through treatment utilizing supercritical water oxidation (SCWO) technology. A reaction utilizing SCWO technology involves reacting the waste with air at temperatures and pressures above the critical point of water (374° C., 221 Bar) to convert all of the organic matter of the waste into clean water and carbon dioxide (CO₂) in a short period of time. Under these conditions, organic matter is typically oxidized at high reaction rates, resulting in complete conversion of the organic matter to CO₂, and usable water at reaction times as short as a few seconds.

The resulting water is divided into two streams, one containing minerals and one distilled water. The mineral stream contains suspended and dissolved inorganic minerals, and is optionally utilized as fertilizer, following further processing. One beneficial feature of using SCWO technology is that the continuous process utilizes the energy embedded in the waste. When the energy balance is positive, this feature allows the units to operate off-the-grid while increasing the system's resiliency. Another benefit is that SCWO systems are more compact compared to other organic waste processing technologies. Further, it is possible to provide a system that normally does not require any reagents or consumables to operate, and that requires no additional external energy other than the initial energy embedded in the waste undergoing treatment and the initial heat provided to the system.

SCWO has been successfully applied to the destruction of problematic contaminants such as chemical weapons, PCBs, chlorinated solvents, coking wastewater, landfill leachate, oily wastes, PFAS, and dye-house wastewater. Unlike other hydrothermal treatment which generally produces an effluent liquid requiring additional processing prior to disposal, SCWO treatment yields relatively clean water. Moreover, formation of NOx, SOx, and other usual by-products of combustion is significantly reduced because of the relatively low process temperatures and water medium of the reaction and the unique properties of the medium in which the reaction takes place.

One drawback of current SCWO processes is that they typically are unable to effectively process wastes which have a very high calorific value. These wastes, often called high-strength wastes, have a significant amount of embedded energy, which is converted into heat during the oxidation reaction. In turn, the final temperature at the end of the oxidation reaction often exceeds the operable temperature range for the materials used in typical reactors. Specifically, most reactors are only able to withstand temperatures below 700° C. However, reaction of high-strength wastes typically entails final temperatures in excess of 700° C. As a result, the high-strength wastes would damage typical SCWO reactors, and need to be diluted to avoid that, which in turn increases the volume of waste requiring treatment.

Additionally, many industrial wastes are classified as high-strength wastes which have calorific values in excess of 3 MJ/kg. Examples of such industrial wastes include legacy stockpiles of aqueous film forming foam (AFFF), spent media from water treatment processes and wastewater polishing processes, chemical wastes, agricultural and food processing wastes, and other concentrated wet wastes.

Importantly, there is a lack of cost-effective and environmentally sound treatment technologies for disposing of high-strength wastes. Generally, treatment of such wastes requires high destruction efficiency to comply with environmental discharge regulations. Accordingly, there is the need for a SCWO system able to effectively handle the high temperatures associated with processing high-strength wastes, and to provide a high level of waste destruction.

### SUMMARY

The above-listed need is met or exceeded by the present supercritical water oxidation (SCWO) system for the treatment of high-strength wastes with calorific values in excess of about 3 MJ/kg. In particular, the present SCWO system includes a combination of a well-mixed SCWO reactor, and an optional polishing reactor connected in series. More specifically, the well-mixed SCWO reactor provides significant thermal inertia, meaning that its temperature will not vary significantly and will be uniform, while its design provides the possibility to extract heat to keep the reactor temperature in the acceptable operating range.

The well-mixed reactor is a reactor where the reagent is rapidly and uniformly mixed throughout the reactor upon entry, and optionally operates using one or more of static and active mixing.

Additionally, the present well-mixed reactor includes a fluid recirculation loop which homogenizes the conditions within the well-mixed reactor and improves the performance of the oxidation reaction. Because of the well-mixed SCWO reactor's large thermal inertia, as well as the recirculation loop, the inlet streams do not necessarily need to be preheated separately prior to mixing into the reactor in order to achieve fast oxidation reactions. Specifically, the recirculation loop recirculates part of the effluent stream from the well-mixed reactor, thereby transferring heat to the other well-mixed reactor inputs. Therefore, separate preheating other than that provided by the recirculation loop is not required. As a result, the present SCWO system does not require expensive and bulky heat exchangers to heat inlet products entering the well-mixed SCWO reactor. However, heat exchangers are still optionally included to improve the efficiency and versatility of the SCWO system.

Another feature of the present well-mixed SCWO reactor is that it is relatively resistant to failure when treating wastes that have a high calorific value, such as high-strength feedstock. Specifically, the well-mixed SCWO reactor includes a heat transfer unit which either extracts heat from, or supplies heat to, the well-mixed SCWO reactor. In this way, the well-mixed SCWO reactor is able to handle high strength feedstock, since the excess energy from the feedstock is extracted by the heat transfer unit. Moreover, the heat transfer unit optionally supplies heat to the well-mixed SCWO reactor when low strength feedstocks are provided.

Additionally, the polishing reactor, which is preferably a tubular or plug-flow reactor for controlled and uniform residence time and for being compatible with enhanced and more consistent destruction efficiency, further reduces the organic load content of the high-strength feedstock to the desired level.

Moreover, the high-strength feedstock undergoes a rapid transition to supercritical conditions, which reduces the corrosion experienced by the well-mixed reactor. In particular, SCWO reactors which slowly heat the waste experience corrosion and undesirable reactions due to the length of time needed to heat the waste and the length of time which the waste spends in the temperature range between 200° C. and 350° C.

Further, the present fluid recirculation loop helps reduce the formation of cold spots within the well-mixed reactor. For most SCWO reactors, when the high-strength feedstock is not preheated, the portion of the SCWO reactor following or downstream of the inlet is typically at a lower temperature than the remainder of the SCWO reactor. This colder portion of the SCWO reactor, referred to as a cold spot, reduces the efficiency of the SCWO reactor.

Further, the polishing reactor reduces the residual organic load in the reacted effluent from the well-mixed reactor to a desired level. Moreover, the present SCWO system optionally utilizes neutralization and fouling mitigation methods.

More specifically, a supercritical water oxidation (SCWO) system is provided, including a well-mixed SCWO reactor, a feedstock supplied to the well-mixed SCWO reactor by a feedstock supply line, a recirculation loop flow regulator in fluid communication with the well-mixed SCWO reactor; and a recirculation loop which includes the well-mixed SCWO reactor and the recirculation loop flow regulator, such that the recirculation loop flow regulator receives an oxidant from an oxidant supply line and a first portion of a reactor effluent from the well-mixed SCWO reactor and supplies the oxidant and the first portion of the reactor effluent to the well-mixed SCWO reactor. A heat transfer unit is operationally associated with the well-mixed reactor and performs at least one of: heating and cooling the well-mixed SCWO reactor.

Preferably, the well-mixed SCWO reactor is a continuously-mixed tank reactor, and the SCWO system includes at least one polishing reactor connected to the well-mixed SCWO reactor, such that the at least one polishing reactor receives a second portion of the reacted feedstock from the well-mixed SCWO reactor.

In preferred embodiments, the temperature within the at least one polishing reactor is between around 300° C. to 700° C., and a co-fuel is supplied to the at least one polishing reactor at an inlet of the at least one polishing reactor or at various locations along the length of the at least one polishing reactor.

In additional preferred embodiments the oxidant is further supplied to the at least one polishing reactor and the temperature within the well-mixed SCWO reactor is between around 200° C. to 700° C.

In yet another preferred embodiment, the recirculation loop flow regulator is an air lift located within the well-mixed SCWO reactor, such that the recirculation loop is located completely within the well-mixed SCWO reactor.

In another preferred embodiment, the recirculation loop flow regulator is an eductor located outside of the well-mixed SCWO reactor. Preferably, the oxidant and the first portion of the reactor effluent mix with the feedstock before reaching the well-mixed SCWO reactor. Preferably still, the oxidant and the first portion of the reactor effluent mix with the feedstock within the well-mixed SCWO reactor.

Preferably, the heat transfer unit includes at least one of: an internal heat exchanger on an interior surface of the well-mixed reactor, a jacketed heat exchanger on an exterior surface of the well-mixed reactor, or an external heat exchanger. Preferably still, the heat transfer unit is in a co-current or counter-current configuration and at least two of the well-mixed SCWO reactors are used in series.

In yet another preferred embodiment, a heat transfer fluid flow regulator controls the flow rate of a heat transfer fluid flowing through the heat transfer unit, such that the heat transfer fluid flow regulator increases the flow rate of the heat transfer fluid to increase the heating or cooling by the heat transfer unit. Preferably, the heat transfer fluid flow regulator is a variable speed pump.

In another preferred embodiment, the heat transfer fluid includes water or a mixture of water and at least one of: ethylene glycol, diethylene glycol, or propylene glycol, or a mineral oil such as a natural hydrocarbon, or an aromatic blend such as synthetic hydrocarbons, or molten salts, or other heat transfer fluids known to those skilled in the art. Preferably, the feedstock is a high-strength feedstock and the at least one polishing reactor is either a continuous-mixed tank reactor or plug-flow reactor.

### BRIEF DESCRIPTION OF THE DRAWINGS

FIG. 1 is a schematic of the present supercritical water oxidation (SCWO) system with an eductor for the treatment of high-strength wastes.

FIG. 2 is a schematic of an alternate embodiment of the present supercritical water oxidation (SCWO) system with an airlift for the treatment of high-strength wastes.

### DETAILED DESCRIPTION

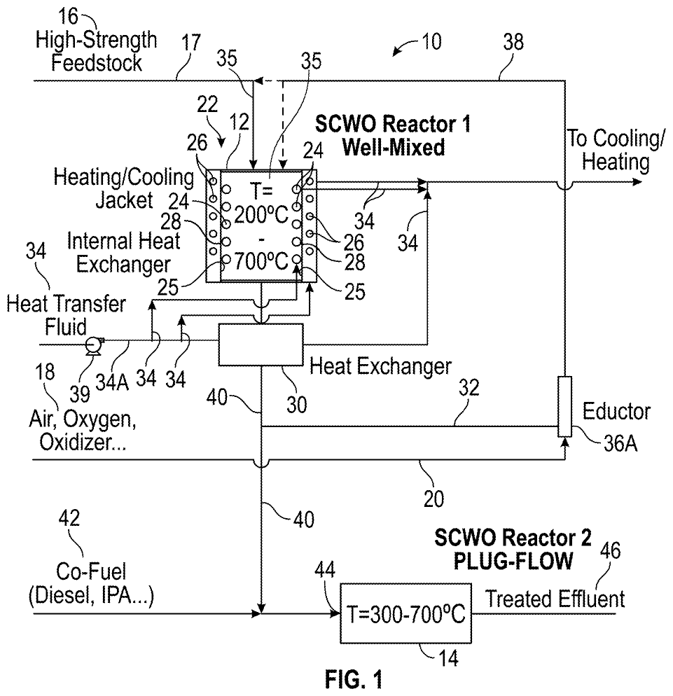

Referring now to FIG. 1, the present supercritical water oxidation (SCWO) system for treatment of high-strength wastes is generally designated 10 and includes a main reactor 12 and an optional polishing reactor 14. In a preferred embodiment, the main reactor 12 is connected in series with, and upstream of, the polishing reactor 14, however other configurations are contemplated. Additionally, a high-strength feedstock 16 is provided to the main reactor 12 by a feedstock supply line 17. Any waste which has a high calorific value is appropriate for use as the high-strength feedstock 16 as is known in the art. In particular, the high-strength feedstock 16 used in the SCWO system 10 typically has a calorific value of at least 3 MJ per kg of waste being treated (MJ/kg) and preferably has a calorific value of at least 3.5 MJ/kg.

Most SCWO processes are typically unable to process feedstocks which have a calorific value outside the range of 2-3 MJ/kg. Examples of the high-strength feedstock 16 include, but are not limited to: unspent aqueous film forming foam (AFFF) used in fire suppression; highly concentrated PFAS, such as concentrates from foam fractionation, membrane processes, or other concentration processes; spent media from water treatment processes and wastewater polishing processes; concentrated chemical wastes; mixed solvent wastes; slaughterhouse wastes; fermentation wastes; food and beverage wastes; miscellaneous agricultural wastes; and oily wastes.

It is also contemplated that instead of the high-strength feedstock 16, a low strength feedstock 16 is optionally processed by the SCWO system 10.

Preferably, the main reactor 12 reduces the organic load or high-strength waste of the high-strength feedstock 16. In particular, the main reactor 12 is a well-mixed reactor, such as a continuously-mixed tank reactor (CMTR), which mixes the contents of the main reactor 12 during the reaction process. Specifically, the well-mixed reactor 12 is configured so that the reagent is rapidly and uniformly mixed throughout the reactor upon entry and optionally operates using more of static and active mixing.

As such, the temperature throughout the main reactor 12 is relatively uniform along its length and is maintained above 200° C., preferably between around 400° C. to 700° C. when the high-strength feedstock 16 includes recalcitrant compounds such as PFAS, PCBs and the like. However, any temperature above 200° C. is appropriate inside the main reactor 12.

Additionally, an oxidant 18 is provided to the main reactor 12 through an oxidant supply line 20. The mass flow rate of the oxidant 18 is optionally controlled by a compressor (not shown). While air and pure oxygen are the preferred oxidants 18, it is understood that other fluids are appropriate for use as the oxidants as is known in the art. The oxidant 18 provides additional oxygen needed for proper reaction within the main reactor 12.

Further, the main reactor 12 optionally includes a heat transfer unit 22 in the form of either an internal heat exchanger 24 on an interior surface 25 of the main reactor 12, a jacketed heat exchanger 26 on an exterior surface 28 of the main reactor or an external heat exchanger 30 used for heating and/or cooling the main reactor.

Preferably, the internal heat exchanger 24 is a coiled pipe which is inserted into the main reactor 12 and is installed along the inner surface 25 of the main reactor. Optionally, the internal heat exchanger 24 includes fins or corrugated pipes to improve the heat transfer performance.

Additionally, the jacketed heat exchanger 26 is also preferably a coiled pipe, which is flattened and attached to the exterior surface 28 of the main reactor 12. Optionally, the jacketed heat exchanger 26 includes fins or corrugations to improve the heat transfer performance.

Since the internal heat exchanger 24 is within the main reactor 12, the internal heat exchanger is configured for withstanding the pressure, temperature, and fluid within the main reactor while it is in operation. However, the internal heat exchanger 24 provides improved heat transfer performance as compared to the jacketed heat exchanger 26, since the internal heat exchanger directly contacts the fluid in the main reactor 12.

The jacketed heat exchanger 26 is less challenging to apply to the main reactor 12 as it is located outside the main reactor and does not need to withstand the conditions within the main reactor. However, the jacketed heat exchanger 26 requires a larger surface area to provide the same amount of heat transfer to or from the main reactor 12.

Both the internal heat exchanger 24 and the jacketed heat exchanger 26 are an integral part of the main reactor 12 instead of ancillary components which are removable.

Alternatively, the internal heat exchanger 24 and the jacketed heat exchanger 26 are optionally finned tube heat exchangers.

The external heat exchanger 30 is preferably displaced from the main reactor 12. While FIG. 1 depicts the heat exchanger 30, it is understood that one or more of the heat transfer units 22 are optionally employed by the SCWO system 10. For example, the SCWO system 10 optionally includes both an internal heat exchanger 24 and an external heat exchanger 30. It is also contemplated that the internal heat exchanger 24, the jacketed heat exchanger 26, and the external heat exchanger 30 are in either a co-current or counter-current configuration as is known in the art.

In addition to receiving the high strength feedstock 16, the main reactor 12 receives a recirculated fluid 32 while the heat transfer unit 22 receives a heat transfer fluid 34 which either transfers heat to, or receives heat from, the main reactor. As illustrated in FIG. 1, the recirculated fluid 32 mixes with the high strength feedstock 16 within the main reactor 12 forming a main reactor input 35. However, it is contemplated that the recirculated fluid 32 mixes with the high strength feedstock 16 in the feedstock supply line 17 prior to reaching the main reactor 12.

Specifically, when it is desirable to reduce the temperature within the main reactor 12, such as when the high-strength feedstock 16 has a high calorific value or the SCWO system 10 is shutting down, the heat transfer unit 22 transfers heat from the fluid within the main reactor to the heat transfer fluid 34. In other words, prior to entering the heat transfer unit 22, the heat transfer fluid 34 is maintained at a lower temperature than the fluid within the main reactor 12.

In one embodiment, the heat transfer fluid 34 is water. Alternatively, the heat transfer fluid 34 is a mixture which includes water and at least one of: ethylene glycol, diethylene glycol, propylene glycol, a natural liquid hydrocarbon such as mineral oil, a synthetic liquid hydrocarbon such as an aromatic blend, or combinations of molten salts, the SCWO effluent and other thermal fluids as are known in the art. The use of different heat transfer fluids 34 allows for operational flexibility in various conditions and ambient temperatures. The heat transfer fluid 34 optionally includes additives that act as corrosion inhibitors, such as silicates, phosphates, mixtures of silicates and phosphates, organic salts and other corrosion inhibitor additives as are known in the art.

Further, the heat transfer fluid 34 optionally transfers heat to the fluid within the main reactor 12, such as during startup, or transition of the SCWO system 10 or when the main reactor is processing the low strength feedstock 16, which lacks the required calorific value to sustain the desired temperature within the main reactor.

Moreover, the SCWO system 10 preferably includes a recirculation loop flow regulator 36, such as an eductor 36A or an air lift 36B, regulates the flow of a recirculation loop 38 within the SCWO system 10. The recirculation loop 38 is constructed and arranged to harmonize the temperature and concentration in the main reactor 12 through forced recirculation of the recirculated fluid 32. Preheating the high strength feedstock 16 often requires bulky and expensive heat exchangers. Therefore, it is desirable to avoid the need to preheat the high-strength feedstock 16 before supplying to the main reactor 12.

In conventional SCWO systems, supplying the feedstock 16 to the main reactor without preheating generally causes a low temperature zone at the inlet of the main reactor. This generally causes reduced performance of the main reactor. However, in the present SCWO system 10, the recirculation loop 38 helps reduce the low temperature zone within the main reactor 12 by harmonizing the temperature within the main reactor, and by offsetting the temperature of the main reactor inputs 35.

Additionally, the recirculation loop 38 promotes heating of main reactor inputs 35, which include the high-strength feedstock 16, the oxidant 18 and any additives (not shown) which are added to the main reactor 12. The recirculation loop 38 also promotes the oxidation reaction whose kinetics are governed in part by temperature.

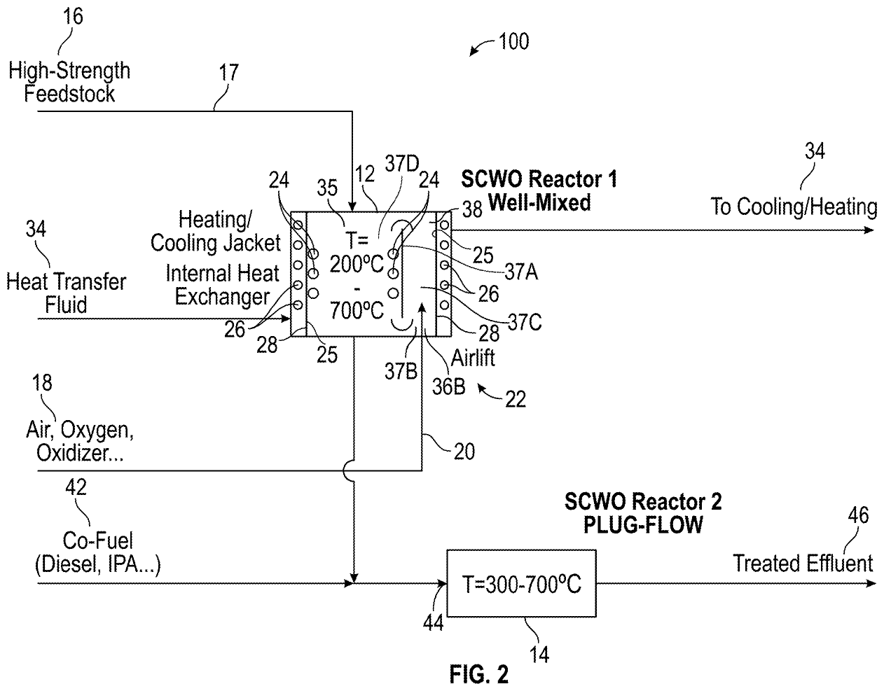

Importantly, the recirculated fluid 32 is mixed with the oxidant 18 by the eductor 36A, thereby forming the recirculation loop 38. Accordingly, the recirculation loop 38 either preheats or cools the oxidant 18, depending on the temperature of the recirculated fluid 32 after leaving the heat transfer unit 22. Typically, the recirculated fluid 32 has a higher temperature than the oxidant 18, such that the recirculated fluid preheats the oxidant 18. While the eductor 36A is depicted as an external unit, it is contemplated that the eductor is optionally internal to the main reactor 12, such as by using baffles 37A to form an air or gas supply zone 37B, a riser region 37C, and a downcomer region 37D, within the main reactor 12 (see FIG. 2).

A heat transfer fluid flow rate regulator 39 controls the flow rate of the heat transfer fluid 34 within the heat transfer unit 22, and is preferably a valve, pump, or other fluid flow regulating device. In a preferred embodiment, the heat transfer fluid flow rate regulator 39 is a variable flow rate pump. Specifically, when the Heating Value (HV) of the high strength feedstock 16 rises rapidly, for example because of the variability of the properties of the high strength feedstock 16, the heat transfer fluid flow rate regulator 39 preferably increases the rate at which the heat transfer fluid 34 flows through the heat transfer unit 22.

A portion of a reacted feedstock stream 40, which is a mixture of supercritical water, process gasses, and suspended minerals leaves the main reactor 12 and travels to the polishing reactor 14. However, a remaining portion of the reacted feedstock stream 40 becomes part of the recirculated fluid 32.

In particular, the recirculated fluid 32, which includes the remaining portion of the reacted feedstock stream 40, provides heat locally to the main reactor inputs 35 in the recirculation loop 38, thereby increasing the reaction rate within the main reactor 12 and reducing corrosion. The flow rate of the recirculated fluid 32 is driven by the flow rate of the oxidant 18 supplied in the oxidant supply line 20. For example, to increase the flow rate of the recirculated fluid 32, the supply of the oxidant 18 is optionally increased. By extension, the flow rate of the oxidant 18 drives the flow rate within the recirculation loop 38.

Alternatively, it is contemplated that an active control device, such as a pump or a valve, controls the flow rate of the recirculated fluid 32 as is known in the art. For example, variable flow pump or other such device optionally increases or decreases the flow rate of the recirculated fluid 32 as needed.

Referring now to FIG. 2, another embodiment of the SCWO system 10 is generally designated 100. Components shared with the SCWO system 10 are designated with identical reference numbers. Within the SCWO system 100, the eductor 36A is removed from the SCWO system 10, and an airlift 36B, which is located within the main reactor 12, creates the recirculation loop 38. The airlift 36B or gas lift 36B includes the air or gas supply zone 37B, the riser region 37C, and the downcomer region 37D, separated by the baffles 37A and connected at both ends as is known in the art. The differences in fluid densities creates a fluid circulation motion between the riser and the downcomer. In this embodiment, the oxidant 18 is fed to the airlift 36B within the main reactor 12, and the SCWO system 10 optionally includes any of the heat transfer units 22 which receive the heat transfer fluid 34. Further, the recirculated fluid 32 forms the recirculation loop 38 within the main reactor 12.

Additionally, the high-strength feedstock 16 undergoes rapid transitioning to supercritical conditions within the main reactor 12 in a matter of seconds. In turn, the main reactor 12 experiences less corrosion, as slow heating of wastes typically causes additional corrosion. However, the main reactor 12 is optionally supplied with a pH control agent and/or a corrosion control agent (not shown). Optionally, the main reactor 12 is also operated at a subcritical temperature if it benefits the treatment of specific wastes. It is also contemplated that the SCWO system 10 optionally includes two or more well-mixed reactors 12 connected in series.

The polishing reactor 14, which is preferably a tubular reactor, is designed to reduce any remaining organic load within the reacted feedstock stream 40, such that minimal amounts of organic load from the high-strength feedstock 16 leave the SCWO system 10 untreated. It is also contemplated that the SCWO system 10 optionally includes two or more polishing reactors 14 connected in series.

Optionally, a co-fuel 42, which is a chemical with a high calorific value, is injected into the polishing reactor 14 to increase its operating temperature. Typical examples of the co-fuel 42 include alcohols, hydrocarbons, gasoline, and diesel. Waste streams such as grease, spent motor oils, and spent lubricating fluid are also appropriate for use as the co-fuel 42. The co-fuel 42 has a low mass flow rate and is generally not preheated.

Moreover, the co-fuel 42 is injected either at an inlet 44 of the polishing reactor 14 or is injected at various locations along the length of the polishing reactor 14. The co-fuel 42 is optionally mixed with the reacted feedstock stream 40 from the main reactor 12 before entering the polishing reactor 14. The co-fuel 42 is injected in an amount sufficient to maintain a high temperature in the polishing reactor 14, preferably in the range of approximately 300-700° C. A treated effluent stream 46 leaves the polishing reactor 14. The temperature range, and residence time, of the polishing reactor 14 is well suited for reducing the organic load of the reacted feedstock stream 40 so that the organic load of the treated effluent stream 46 is at the desired treatment levels. The residence time of the polishing reactor 14 is typically at least 10 seconds and preferably closer to 30 seconds or more.

Further, the polishing reactor 14 is optionally supplied with the oxidant 18 (not shown), a pH control agent and/or a corrosion control agent (not shown). Each of the oxidant 18, the pH control agent and/or the corrosion control agent are optionally injected either prior to or directly within the polishing reactor 14. After leaving the polishing reactor 14, the treated effluent 46 optionally passes through at least one treated effluent heat exchanger (not shown) intended to recover heat supplied to the treated effluent 46 in the polishing reactor 14. Additionally, the at least one treated effluent heat exchanger optionally preheats either the oxidant 18, the high-strength feedstock 16 or the reacted feedstock stream 40, or a combination of them or all of them, while reducing the temperature of the treated effluent 46. While not depicted, it is contemplated that the at least one treated effluent heat exchanger heat is optionally located between the main reactor 12 and the polishing reactor 14.

Additionally, the treated effluent 46 optionally passes through a phase separator (not shown) where the permanent gases are separated from the liquid and minerals suspension of the treated effluent 46. Accordingly, the stream of permanent gases and the stream of liquid and minerals suspension are depressurized separately by pressure reducing devices (not shown). Alternatively, the unseparated treated effluent 46, which includes the permanent gases as well as the liquid and minerals suspension, is depressurized by a joint pressure reducing device (not shown). An example of the joint pressure reducing device is a capillary.

Moreover, the mass flow rate of the high-strength feedstock 16, the oxidant 18, the heat transfer fluid 34, the co-fuel 42, the optional pH control agent, and other optional additives are each controlled by fluid flow devices such as valves, pumps, or other devices which regulate the flow of fluid. In a preferred embodiment, the mass flow rate of the high-strength feedstock 16, the oxidant 18, the co-fuel 42, the optional pH control agent, and other optional additives are regulated by high pressure variable flow rate pumps (not shown) which are connected to and controlled by a controller (not shown). Preferably, the controller receives inputs from a variety of sensors (not shown) and mass flow rate meters (not shown), as well as optionally from an operator of the SCWO system 10. Additionally, the components of the SCWO system 10 are made of temperature, pressure, and corrosion resistant materials or alloys as are known in the art.

Moreover, the heat extracted by the heat transfer unit 22 is optionally used for various alternative purposes, such as power generation. For example, when water is used as the heat transfer fluid 34, the heat transfer fluid is optionally converted to steam which is used for power generation. It is also contemplated that the heat transfer fluid 34 is optionally used as a source of hot water, either directly or indirectly through one or more heat exchangers.

To illustrate the effectiveness of the SCWO system 10, the inventors developed a simulated model of the SCWO system 10 similar to that shown in FIG. 1. The simulated model of the SCWO system 10 supplied the recirculated fluid 32 to the feedstock supply line 17, such that the feedstock 16 mixed with the recirculated fluid before reaching the main reactor 12. Through the use of a thermodynamic package, following model assumptions and inputs, the inventors were able to determine the required heat transfer fluid 34 flow rate for a given feedstock 16. In the simulation, a solution of isopropyl alcohol (IPA) in water was used as the feedstock 16.

For the simulation, the following inputs were required: the operating pressure; the feedstock 16 mass flow rate; the feedstock inlet temperature; the feedstock composition (IPA wt. % in water); the oxygen excess target; the target temperature of the main reactor inputs 35 prior to reaching the main reactor 12; the target temperature at the outlet of the main reactor; and the oxidation reaction stoichiometry. Based on these inputs, the model adjusted the oxidant 18 flow rate to match the oxygen excess target, adjusted the flow rate of the recirculated fluid 32 to match the mixing temperature target, and calculated the required heating or cooling (depending on the feedstock 16 calorific value) to match the desired temperature within the main reactor 12.

In the simulation, the heat transfer fluid 34 was water and three different types of feedstocks 16 were tested. Specifically, the feedstock 16 had three different calorific values, namely 7.5 MJ/kg, 5.6 MJ/kg, and 3.1 MJ/kg.

The simulation demonstrates how the heat transfer fluid 34 within the heat transfer unit 22 was able to sufficiently reduce the temperature within the main reactor 12 to within an acceptable range. Table 1 below shows the model inputs for each of the three feedstocks 16 tested.

Table 2 shows the model outputs from the simulation, including the cooling duty from the heat transfer unit 22 and the required flow rate of the heat transfer fluid 34 needed to sufficiently bring the temperature inside the well-mixed SCWO reactor 12 within an acceptable temperature range. The cooling duty quantifies the amount of energy that needs to be extracted from the main reactor 12 so that the main reactor reaches the desired temperature. In the simulation, the temperature of the main reactor 12 after the heat transfer unit 22 was set to 620° C. The recirculated ratio quantifies the portion of the reacted feedstock stream 40 which forms the recirculated fluid 32. Specifically, the recirculated ratio is the amount of the reacted feedstock stream 40 which forms the recirculated fluid 32 divided by the entire reacted feedstock stream.

Table 2 shows the preferred recirculated fluid 32 and oxidant 18 flow rate for each case. As discussed above, the flow rate of the oxidant 18 drives the flow rate of the recirculated fluid 32, and by extension the flow rate within the recirculation loop 38. For the purposes of the simulation, the flow rate of the oxidant 18 was set to achieve the desired recirculated fluid 32 flow rate, resulting in a preferred temperature of the main reactor inputs 35.

Table 2 also shows the theoretical temperature within the main reactor 12 if the heat transfer unit 22 were not included in the simulated model.

For the simulation shown in Table 1, the following inputs remained constant: the target temperature of the main reactor input 35 in the mixing zone (set to 400° C.), the target temperature at the outlet of the main reactor 12 (set at 620° C.), the feedstock 16 inlet flow rate (which was taken at 250 kg/h), and the ratio between oxygen initially available and oxygen consumed (taken at 10%). The mixing zone is the portion of the feedstock supply line 17 after the recirculated fluid 32, the oxidant 18, and the feedstock 16 mix before reaching the main reactor 12 or a narrow zone inside the main reactor if the main reactor inputs 35 mix within the main reactor.

TABLE 1

| | HV theoretical | Heat of reaction | | |
|---|---|---|---|---|
| | (MJ/kg) | theoretical (kW) | T_feedstock_hot | T_air_hot |
| | Theoretical HV | Theoretical heat of | (° C.) | (° C.) |
| | based on IPA | reaction based on HV | Feedstock reactor | Air reactor inlet |
| Details | concentration | and mass flow rate | inlet temperature | temperature |
| Case 1 | 3.1 | 217 | 100 | 100 |
| Case 2 | 3.1 | 217 | 100 | 500 |
| Case 3 | 3.1 | 217 | 250 | 100 |
| Case 4 | 3.1 | 217 | 250 | 500 |
| Case 5 | 5.6 | 390 | 100 | 100 |
| Case 6 | 5.6 | 390 | 100 | 500 |
| Case 7 | 5.6 | 390 | 250 | 100 |
| Case 8 | 5.6 | 390 | 250 | 500 |
| Case 9 | 7.5 | 520 | 100 | 100 |
| Case 10 | 7.5 | 520 | 100 | 500 |
| Case 11 | 7.5 | 520 | 250 | 100 |
| Case 12 | 7.5 | 520 | 250 | 500 |

TABLE 2

| | AirFl | Mixing Temperature (° C.) | |
|---|---|---|---|
| | (kg/h) | Actual temperature at the mixing | RR recirculation ratio |
| | Air inlet | zone between the inlet feedstock and | Recirculated ratio at |
| Details | feedstock | recirculated effluent and air | the effluent split |
| Case 1 | 311 | 402 | 0.78 |
| Case 2 | 311 | 399 | 0.74 |
| Case 3 | 311 | 402 | 0.72 |
| Case 4 | 311 | 398 | 0.66 |
| Case 5 | 560 | 400 | 0.75 |
| Case 6 | 560 | 400 | 0.66 |
| Case 7 | 560 | 399 | 0.69 |
| Case 8 | 560 | 401 | 0.58 |
| Case 9 | 747 | 398 | 0.72 |
| Case 10 | 747 | 399 | 0.61 |
| Case 11 | 747 | 401 | 0.68 |
| Case 12 | 747 | 402 | 0.51 |

| Reacted Fl | | | |
|---|---|---|---|
| (kg/h) | T_react_hot (° C.) | | |
| Resulting | Theoretical temperature | | Heat transfer Fluid |
| recirculated fluid | within the main reactor | Cooling duty (kW) | Flow Rate (kg/h) |
| and oxidant flow | if there were no heat | Actual cooler | Water at a |
| rate | transfer unit | heat duty | pressure of 5 bar |
| 2,486.7 | 578 | −52 | 0 |
| 2,104.0 | 608 | −13 | 0 |
| 2,008.1 | 621 | 1 | 25 |
| 1,629.4 | 669 | 39 | 1,691 |
| 3,162.1 | 685 | 90 | 5,368 |
| 2,426.7 | 769 | 159 | 6,856 |
| 2,614.3 | 742 | 140 | 6,033 |
| 1,912.6 | 867 | 210 | 9,033 |
| 3,571.3 | 751 | 196 | 8,426 |
| 2,563.4 | 886 | 289 | 12,426 |
| 3,063.8 | 810 | 245 | 10,555 |
| 2,051.3 | 1,006 | 338 | 14,555 |

As shown in Table 2, the theoretical temperature within the main reactor 12 if no heat transfer unit 22 were present is as high as 1006° C. This is well beyond the operational range of the main reactor 12. As such, the main reactor 12 would be damaged if it handled the high-strength feedstocks 16 above 700° C. shown in Table 2. However, in each simulation, the temperature at the outlet of the main reactor 12 was set to 620° C., and the required heat transfer fluid 32 flow rate was determined. This demonstrates that, by supplying the heat transfer fluid 32 at a sufficient flow rate, the main reactor 12 optionally treats high-strength feedstocks 16.

The modeling also shows that the SCWO system 10 is able to optionally treat high-strength feedstocks 16 due to the heat transfer unit 22 which extracts sufficient heat to maintain the main reactor 12 within acceptable working conditions. Moreover, this simulation shows that, with the aid of the recirculation loop 38, the SCWO system 10 increases the mixing temperature of the main reactor inputs 35 to the desired range, which helps achieve quicker reaction onset and helps mitigate corrosion.

As the results in Table 2 demonstrate, the SCWO system 10 is able to optionally process high-strength feedstock 16 without preheating of the high-strength feedstock or the oxidant 18. Surprisingly and unexpectedly, because of the recirculation loop 38, in combination with the heat transfer unit 22, the SCWO system 10 operates more efficiently and requires less cooling duty, and a lower flow rate of the heat transfer fluid 34 when the high strength feedstock 16 and the oxidant 18 are not preheated.

In particular, when the oxidant 18 and the feedstock 16 were preheated, additional heat transfer fluid 34 was required to reduce the temperature within the main reactor 12 to the desired temperature. Moreover, when the oxidant 18 and the feedstock 16 were not preheated, the flow rate of the recirculation loop 38 was increased, thus reducing cold spots within the main reactor 12. As a result, the SCWO system 10 operated effectively when the oxidant 18 and feedstock 16 were not preheated, and the SCWO system 10 effectively processed the high strength feedstocks 16.

While a particular embodiment of the present supercritical water oxidation (SCWO) system for treatment of high-strength wastes has been described herein, it will be appreciated by those skilled in the art that changes and modifications may be made thereto without departing from the invention in its broader aspects and as set forth in the following claims.

1. A supercritical water oxidation (SCWO) system, comprising:
a well-mixed SCWO reactor;
a feedstock supplied to said well-mixed SCWO reactor by a feedstock supply line;
a recirculation loop flow regulator in fluid communication with said well-mixed SCWO reactor;
a recirculation loop which includes said well-mixed SCWO reactor and said recirculation loop flow regulator, such that said recirculation loop flow regulator receives an oxidant from an oxidant supply line and a first portion of a reactor effluent from said well-mixed SCWO reactor and supplies said oxidant and said first portion of said reactor effluent to said well-mixed SCWO reactor; and
a heat transfer unit operationally associated with said well-mixed reactor which performs at least one of:
heating said well-mixed SCWO reactor; and
cooling said well-mixed SCWO reactor.

2. The SCWO system of claim 1, wherein said well-mixed SCWO reactor is a continuously-mixed tank reactor.

3. The SCWO system of claim 1, further comprising:
at least one polishing reactor connected to said well-mixed SCWO reactor, such that said at least one polishing reactor receives a second portion of said reacted feedstock from said well-mixed SCWO reactor.

4. The SCWO system of claim 3, wherein the temperature within said at least one polishing reactor is between around 300° C. and 700° C.

5. The SCWO system of claim 3, wherein a co-fuel is supplied to said at least one polishing reactor at an inlet of said at least one polishing reactor or at various locations along the length of said at least one polishing reactor.

6. The SCWO system of claim 3, wherein said oxidant is further supplied to said at least one polishing reactor.

7. The SCWO system of claim 1, wherein the temperature within said well-mixed SCWO reactor is between around 200° C. and 700° C.

8. The SCWO system of claim 1, wherein said recirculation loop flow regulator is an air lift located within said well-mixed SCWO reactor, such that said recirculation loop is completely within said well-mixed SCWO reactor.

9. The SCWO system of claim 1, wherein said recirculation loop flow regulator is an eductor located outside of said well-mixed SCWO reactor.

10. The SCWO system of claim 9, wherein said oxidant and said first portion of said reactor effluent mix with said feedstock before reaching said well-mixed SCWO reactor.

11. The SCWO system of claim 9, wherein said oxidant and said first portion of said reactor effluent mix with said feedstock within said well-mixed SCWO reactor.

12. The SCWO system of claim 1, wherein said heat transfer unit includes at least one of:
an internal heat exchanger on an interior surface of said well-mixed reactor;
a jacketed heat exchanger on an exterior surface of said well-mixed reactor; and
an external heat exchanger.

13. The SCWO system of claim 1, wherein said heat transfer unit is in a co-current or counter-current configuration.

14. The SCWO system of claim 1, wherein at least two of said well-mixed SCWO reactors are used in series.

15. The SCWO system of claim 1, further comprising:
a heat transfer fluid flow regulator which controls the flow rate of a heat transfer fluid flowing through said heat transfer unit, wherein said heat transfer fluid flow regulator increases the flow rate of said heat transfer fluid to increase the heating or cooling by said heat transfer unit.

16. The SCWO system of claim 15, wherein said heat transfer fluid flow regulator is a variable speed pump.

17. The SCWO system of claim 1, wherein said heat transfer fluid comprises water or a mixture of water and at least one of: ethylene glycol; diethylene glycol; propylene glycol; a mineral oil such as a natural hydrocarbon; an aromatic blend such as synthetic hydrocarbons; molten salts; and said reactor effluent.

18. The SCWO system of claim 1, wherein said feedstock is a high-strength feedstock.

19. The SCWO system of claim 3, wherein said at least one polishing reactor is either a tubular or plug-flow reactor.

20. The SCWO system of claim 1, wherein said feedstock is a low-strength feedstock.
